(19) United States
(12) Patent Application Publication
(10) Pub. No.: US 2017/0004910 A1
(43) Pub. Date: Jan. 5, 2017

(54) MAGNETIC COMPOSITE AND METHOD OF MANUFACTURING THE SAME

(71) Applicant: Samsung Electro-Mechanics Co., Ltd., Suwon-si (KR)

(72) Inventors: Seung Ho LEE, Suwon-si (KR); In Gyu KIM, Suwon-si (KR)

(73) Assignee: Samsung Electro-Mechanics Co., Ltd., Suwon-si (KR)

(21) Appl. No.: 15/014,967

(22) Filed: Feb. 3, 2016

(30) Foreign Application Priority Data
Jun. 30, 2015 (KR) 10-2015-0092907

(51) Int. Cl. H01F 1/01; B22F 9/04; B22F 3/20; B22F 3/18; B22F 1/00; B22F 3/105

(52) U.S. Cl. CPC H01F 1/015; B22F 1/0003; B22F 3/105; B22F 3/20; B22F 3/18; B22F 9/04; B22F 2003/1051; B22F 2003/208; B22F 2003/185; B22F 2009/043; B22F 2301/058; B22F 2301/052

(57) ABSTRACT

A magnetic composite and a method of manufacturing the same are provided. The magnetic composite includes a magnetic material including magnetic material particles and a metal alloy.

### CROSS-REFERENCE TO RELATED APPLICATION

This application claims the benefit under 35 USC 119(a) of Korean Patent Application No. 10-2015-0092907 filed on Jun. 30, 2015, in the Korean Intellectual Property Office, the entire disclosure of which is incorporated herein by reference for all purposes.

### BACKGROUND

1. Field

The following description relates to a magnetic composite and a method of manufacturing the same.

2. Description of Related Art

Magnetic refrigeration technology is a technology of obtaining refrigeration depending on a change in a magnetic field using a solid magnetic refrigerant having a magnetocaloric effect. In order to implement the magnetic refrigeration technology, a system including configurations such as a magnetic composite, a magnetic field generator (a permanent magnet), heat exchange fluid, and the like, is required.

In order to secure heat exchange efficiency between the magnetic composite and the heat exchange fluid and smooth fluid circulation, a magnetic composite is formed into an article having a suitable shape. The magnetic composite may be processed into various shapes such as a sphere, a plate, a micro-channel, a micro-fin, a honeycomb, and the like.

The magnetic composite is a composition of matter containing a magnetic material. The magnetic material is mostly crystalline material. The magnetic composite is manufactured into a form capable of being applied to the magnetic refrigeration technology by forming the magnetic material from corresponding raw materials and performing sintering-synthesis, or by synthesizing the magnetic material in a powder form and then pressurizing and sintering the synthesized magnetic material. The mechanical properties of a magnetic composite containing a magnetic material, which is a crystalline material, may deteriorate.

The magnetic composite manufactured using the methods as described above has a limitation in regard to a precise shape being manufactured and mechanical brittleness caused by properties of a crystalline magnetic material being overcome.

Therefore, in the magnetic composite, it is desirable to secure excellent adhesion between components contained therein and to maintain properties of the magnetic material. Further, it is desirable to shape a magnetic composite into a precise and dense shape by selecting an appropriate material and molding conditions.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a magnetic composite includes a magnetic material including magnetic material particles, and a metal alloy.

The metal alloy may be a eutectic alloy.

The eutectic alloy may be a binary, ternary, quaternary, or quinary alloy.

The eutectic alloy may be an alloy comprising one or more elements selected from a group consisting of indium (In), tin (Sn), cadmium (Cd), bismuth (Bi), silver (Ag), gold (Au), lead (Pb), zinc (Zn), copper (Cu), germanium (Ge), silicon (Si), aluminum (Al), magnesium (Mg), calcium (Ca), and antimony (Sb).

The magnetic material particles may be single phase particles dispersed in a binder comprising the metal alloy.

The magnetic material may include at least one selected from a group consisting of a magnetocaloric material, a soft magnetic material, and a ferromagnetic material.

The magnetic material may be an alloy, an oxide, or a nitride containing at least one selected from a group consisting of iron (Fe), manganese (Mn), cobalt (Co), nickel (Ni), niobium (Nb), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), boron (B), silicon (Si), germanium (Ge), gallium (Ga), arsenic (As), antimony (Sb), tellurium (Te), phosphorus (P), and bismuth (Bi).

A particle size of the magnetic material may be 10 nm to 100 μm.

The article may have a shape of a sphere, a plate, a micro-channel, a micro-fin, or a honeycomb.

In another general aspect, a method of manufacturing a magnetic composite involves obtaining a magnetic material, mixing the magnetic material and a metal alloy with each other to obtain a mixture, and forming the magnetic composite from the mixture.

The metal alloy may be a eutectic alloy.

The eutectic alloy may be a binary, ternary, quaternary, or quinary alloy.

The eutectic alloy may be an alloy comprising an element selected from a group consisting of indium (In), tin (Sn), cadmium (Cd), bismuth (Bi), silver (Ag), gold (Au), lead (Pb), zinc (Zn), copper (Cu), germanium (Ge), silicon (Si), aluminum (Al), magnesium (Mg), calcium (Ca), and antimony (Sb).

The magnetic material may include a plurality of single phase particles.

The forming of the magnetic composite may be performed at a temperature that is lower than a melting temperature of the magnetic material but higher than a melting temperature of the metal alloy, and at which the magnetic material is formed into single phase particles dispersed in a binder comprising the metal alloy.

The forming of the magnetic composite may be performed by one method selected from a hot press forming method, a hot extrusion forming method, a hot rolling forming method, and a spark plasma sintering method.

The magnetic composite may be formed into an article having a shape of a sphere, a plate, a micro-channel, a micro-fin, or a honeycomb.

In another general aspect, a method of manufacturing a magnetic composite involves obtaining a mixture of a molten metal alloy and a magnetic material at a temperature between a melting temperature of the metal alloy and a melting temperature of the magnetic material, and cooling the mixture to obtain the magnetic composite in which magnetic material particles are dispersed in the metal alloy.

The magnetic material particles in the magnetic composite may be single phase particles.

The magnetic material particles may have a particle size in a range of approximately 10 nm to 100 μm.

The cooling of the mixture may involve molding the mixture into an article having a shape of a sphere, a plate, a micro-channel, a micro-fin, or a honeycomb.

Other features and aspects will be apparent from the following detailed description, the drawings, and the claims.

### BRIEF DESCRIPTION OF DRAWINGS

FIGS. 1 through 3 are cross-sectional views illustrating an example of a method of manufacturing a magnetic composite according to the present description.

FIG. 4 is an electron microscope photograph of a cross-section of an example of a magnetic composite according to the present description.

FIG. 5 is a graph illustrating X-ray diffraction patterns of examples of magnetic composites according to the present description.

FIG. 6 is a graph illustrating magnetization of examples of magnetic composites based on temperature.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

In the drawings, the shapes and dimensions of elements may be exaggerated for clarity, and the same reference numerals will be used throughout to designate the same or like elements.

Hereinafter, a magnetic composite according to the present disclosure will be described.

A magnetic composite according to an example may contain a magnetic material and a metal alloy.

As the magnetic material, any material may be used without limitation as long as it is magnetized by a magnetic field. For example, the magnetic material may include at least one of magnetocaloric materials, soft magnetic materials, and ferromagnetic materials.

The magnetic material may be an alloy, an oxide, or a nitride containing at least one selected from iron (Fe), manganese (Mn), cobalt (Co), nickel (Ni), niobium (Nb), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), boron (B), silicon (Si), germanium (Ge), gallium (Ga), arsenic (As), antimony (Sb), tellurium (Te), phosphorus (P), and bismuth (Bi).

The magnetic material may be, for example, a metal alloy or intermetallic compound such as gadolinium (Gd), gadolinium (Gd)-silicon (Si)-germanium (Ge), manganese (Mn)-arsenic (As), manganese (Mn)-iron (Fe)-phosphorus (P)—X (X is arsenic (As), germanium (Ge), or silicon (Si)), manganese (Mn)-cobalt (Co)-silicon (Si), lanthanum (La)-iron (Fe)-silicon (Si), nickel (Ni)-manganese (Mn)-gallium (Ga), or the like, as the magnetocaloric material; iron (Fe), iron (Fe)-silicon (Si), cobalt (Co)-iron (Fe), iron (Fe)-nitrogen (N), or the like, as the soft magnetic material; or neodymium (Nd)-iron (Fe)-boron (B), neodymium (Nd)-dysprosium (Dy)-iron (Fe)-boron (B), samarium (Sm)-cobalt (Co), samarium (Sm)-iron (Fe)-nitrogen (N), ferrite, Alnico, or the like, as the ferromagnetic material. However, the magnetic material is not limited thereto.

According to one example, the magnetic material may be contained in a form of particles, and a particle size of the magnetic material may be 10 nm to 100 μm.

By setting the particle size of the magnetic material in a range of approximately 10 nm to 100 μm, the generation of cracks by magnetic hysteresis and thermal hysteresis may be prevented. Thus, magnetic refrigeration efficiency and lifespan characteristics may be improved.

A magnetic composite according to the related art may contain a binder containing glass between magnetic material particles. The glass is in an amorphous state in which two or more elements have disorderly atom structures and has a high melting temperature due to a complicated element composition and because mechanical properties thereof are weak, in a case of the magnetic composite containing the glass, mechanical properties thereof are deteriorated.

The magnetic composite according to an example of the present description may contain a metal alloy.

The magnetic material may be formed as single phase particles.

A content of the metal alloy may be suitably selected and in a range in which the magnetic material may be formed as single phase particles mixed in the metal alloy binder when the magnetic composite is manufactured.

In the event that the content of the metal alloy in the magnetic composite is greater than a suitable content range, a secondary phase may form by a reaction between the magnetic material and the metal alloy. The formation of the secondary phase may deteriorate magnetic properties and magnetic refrigeration properties of the magnetic material.

Therefore, the content of the metal alloy may satisfy the range in which the magnetic material may be formed as single phase particles, and thus coupling force of the magnetic material may be improved and physical properties of the magnetic material may be secured.

The metal alloy may be a eutectic alloy, and may be a binary, ternary, or higher alloy.

The eutectic alloy may be an alloy of elements selected from indium (In), tin (Sn), cadmium (Cd), bismuth (Bi), silver (Ag), gold (Au), lead (Pb), zinc (Zn), copper (Cu), germanium (Ge), silicon (Si), aluminum (Al), magnesium (Mg), calcium (Ca), and antimony (Sb).

The eutectic alloy, an alloy having a eutectic composition of two or three kinds of metals, has a lower melting point compared to other compositions besides the eutectic composition. In an example in which the eutectic alloy is a binary alloy, a component ratio at which components simultaneously melt is referred to as a cryohydric point or eutectic point, and a melting temperature at this time is referred to as a cryohydric temperature or eutectic temperature (Te).

The eutectic alloy may have a melting temperature lower than that of the magnetic material. Therefore, the eutectic alloy may serve as a binder binding a material, and heat conductivity between the magnetic material particles may be increased.

Since the eutectic alloy melts at a temperature lower than a sintering temperature of the magnetic material, the eutectic alloy does not have an influence on physical properties of the magnetic material, and may serve as the binder between the magnetic material particles. Thus, the eutectic alloy may be processed and formed as a bulk material such as the magnetic composite.

The eutectic alloy may be mixed with the magnetic material to thereby be formed when the magnetic composite is manufactured. The molding may be performed by applying heat.

When a heating temperature is equal to or higher than the eutectic temperature, the eutectic alloy may melt, and thus a first-order phase transition may occur. Thereafter, when cooling is performed, the eutectic alloy may be contained in the magnetic composite, and thus the magnetic material may be formed as a single phase material. In this process, the physical properties of the magnetic material may be secured, and the molding may be easily performed.

However, when the molding is performed, when the eutectic alloy and the magnetic material react with each other, a secondary phase besides the single phase may be formed. Thereafter, when cooling is performed, the secondary phase besides the single phase of the magnetic material may be contained in the magnetic composite. Therefore, magnetic properties of the magnetic composite may be deteriorated.

Therefore, in order to prevent the secondary phase from being formed by the reaction between the magnetic material and the eutectic alloy, there is a need to optimize the content of the eutectic alloy, and a molding temperature also needs to be in a range in which the secondary phase is not formed.

The eutectic alloy may be a solid metal existing in a solid state at room temperature as illustrated in [Table 1] and [Table 2], and a numerical value for each element in the composition indicates a content (wt %).

TABLE 1

| Composition | Te (° C.) |
|---|---|
| In₅₂Sn₄₈ | 118 |
| In₇₄Cd₂₆ | 123 |
| Bi₅₈Sn₄₂ | 138 |
| In97Ag3 | 143 |
| In_{99.4}Au_{0.6} | 156 |
| Sn₆₃Pb₃₇ | 183 |
| Sn₉₁Zn₉ | 199 |
| Sn₉₀Au₁₀ | 217 |
| Sn_{96.5}Ag_{3.5} | 221 |
| Sn_{99.3}Cu_{0.7} | 227 |
| Sn₉₅Cu₅ | 231 |
| Bi₈₂Au₁₈ | 241 |
| Bi_{97.5}Ag_{2.5} | 263 |
| Cd_{82.5}Zn1_{7.5} | 265 |
| Sn₂₀Au₈₀ | 280 |
| Au_{87.5}Ge_{12.5} | 361 |
| Au_{97.1}Si_{2.9} | 370 |
| Zn₉₅Al₅ | 382 |
| Al₄₉Ge₅₁ | 419 |
| Mg₆₇Al₃₃ | 437 |
| Ca₇₃Al₂₇ | 545 |
| Al₆₇Cu₃₃ | 548 |
| Al_{87.5}Si_{12.5} | 580 |
| Ag_{71.9}Cu_{28.1} | 779 |

TABLE 2

| Composition | Te (° C.) |
|---|---|
| Bi_{44.7}Pb_{22.6}Sn_{8.3}In_{19.1}Cd_{5.3} | 47 |
| Bi₄₉Pb₁₈Sn₁₂In₂₁ | 58 |
| In₅₁Bi_{32.5}Sn_{16.5} | 60.5 |
| In_{61.7}Bi_{30.8}Cd_{7.5} | 62 |
| Bi₅₀Pb₂₅Sn_{12.5}Cd_{12.5} | 71 |
| Sn_{51.2}Pb_{30.6}Cd_{18.2} | 145 |
| Sn₇₀Pb₁₈In₁₂ | 165~167 |
| Sn₆₂Pb₃₆Ag₂ | 179 |
| Sn₆₂Pb₃₇Cu₁ | 183 |
| Sn_{95.5}Ag₄Cu_{0.5} | 217 |
| Sn₆₅Ag₂₅Sb₁₀ | 233 |
| Sn₅Pb₉₀Ag₅ | 292 |
| Sn_{97.5}Pb₁Ag_{1.5} | 305 |
| Sn₁Pb_{97.5}Ag_{1.5} | 309 |

Hereinafter, an example of a method of manufacturing a magnetic composite will be described.

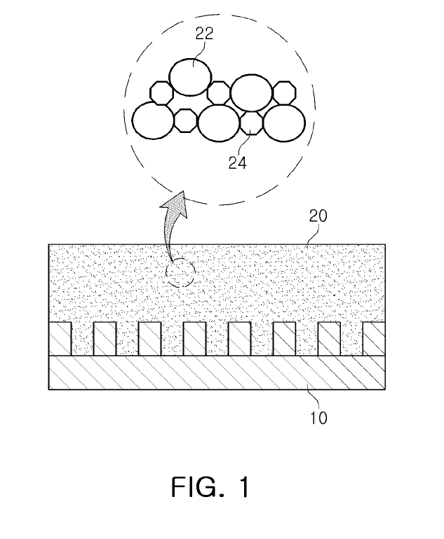

FIGS. 1 through 3 schematically illustrate an example of a method of manufacturing a magnetic composite.

Referring to FIGS. 1 through 3, the method of manufacturing a magnetic composite involves: preparing a magnetic material 24; mixing the magnetic material 24 and a metal alloy 22 with each other to obtain a mixture; and forming the mixture.

First, the magnetic material 24 may be prepared. The magnetic material 24 may be at least one of magnetocaloric materials, soft magnetic materials, and ferromagnetic materials, and may be obtained by uniformly mixing precursors such as an alloy, an oxide, or a nitride containing at least one selected from iron (Fe), manganese (Mn), cobalt (Co), nickel (Ni), niobium (Nb), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), boron (B), silicon (Si), germanium (Ge), gallium (Ga), arsenic (As), antimony (Sb), tellurium (Te), phosphorus (P), and bismuth (Bi) with a reducing agent, and heat-treating the mixture.

The reducing agent may be, for example, at least one of lithium (Li), sodium (Na), and potassium (K), at least one of beryllium (Be), magnesium (Mg), calcium (Ca), strontium (Sr), and radium (Ra), or aluminum (Al), and be present in a state in which the reducing agent is uniformly dispersed in the mixture.

An oxidation reaction of the reducing agent may occur, and at this time, heat may be generated. The heat from the oxidation reaction may uniformly heat the mixture, and thus reactions between materials contained in the mixture may be carried out entirely.

An oxide formed by the oxidation reaction of the reducing agent may be formed between the magnetic material particles, and the oxide and the magnetic material do not generate a chemical reaction. That is, the oxide may control growth of the magnetic material, thereby adjusting the particle size and uniformity of the magnetic material.

As a method of mixing the precursor with the reducing agent to obtain the mixture, one selected from a ball mill method, an attrition mill method, a jet mill method, and a spike mill method may be used, and this method may be performed under an inert gas atmosphere such as an argon atmosphere, or the like, a reducing atmosphere, such as a hydrogen atmosphere, or the like, a vacuum atmosphere, or an air atmosphere containing oxygen. However, the method is not limited thereto.

A heat-treatment method of the mixture may be, for example, one selected from a heating method, a heating method using microwaves, an induction heating method, and a spark plasma sintering method.

When heat-treatment is performed, a heat-treatment temperature may be lower than the melting point of the magnetic material. For example, the heat-treatment may be performed at 500° C. to 1,200° C. When the heat-treatment temperature satisfies the heat-treatment temperature range, the precursor may efficiently react, and thus the magnetic material particles may be effectively formed.

The reducing agent may be oxidized by heat-treatment of the mixture, and thus the oxide may be obtained, and the precursor may be reduced, and thus the magnetic material 24 having magnetism may be obtained in a form of particles.

Referring to FIG. 1, a mixture 20 may be obtained by mixing the obtained magnetic material 24 and the metal alloy 22 with each other. The mixing may be performed, for example, by one method selected from a ball mill method, an attrition mill method, a jet mill method, and a spike mill method, but is not limited thereto.

The magnetic material 24 in the mixture may be single phase particles.

A content of the metal alloy may be suitably designed, and the content may be in a range in which the magnetic material particles may be formed as single phase particles when the magnetic composite is manufactured.

When the content of the metal alloy 22 is more than a suitable content range, a secondary phase may be formed by a reaction between the magnetic material and the metal alloy, and thus, magnetic properties and magnetic refrigeration properties of the magnetic material may be deteriorated.

Therefore, the content of the metal alloy may satisfy the range in which the magnetic material may be formed as the single phase, and thus coupling force of the magnetic material may be improved, and physical properties of the magnetic material may be secured.

The metal alloy 22 may be a eutectic alloy, and may be a binary, ternary, or higher alloy.

The eutectic alloy 22 may be an alloy of elements selected from indium (In), tin (Sn), cadmium (Cd), bismuth (Bi), silver (Ag), gold (Au), lead (Pb), zinc (Zn), copper (Cu), germanium (Ge), silicon (Si), aluminum (Al), magnesium (Mg), calcium (Ca), and antimony (Sb).

The eutectic alloy 22 may have a melting temperature lower than that of the magnetic material 24. Therefore, the eutectic alloy 22 may serve as a binder binding the particles of the magnetic material 24, and may serve to promote the heat transferring between the magnetic material particles, thereby increasing heat conductivity of the magnetic composite.

Next, referring to FIGS. 2 and 3, a mixture 30 of the magnetic material 24 and the metal alloy 22 may be formed.

A molding process may be performed at a temperature that is lower than the melting temperature of the magnetic material 24 but higher than the melting temperature of the metal alloy 22, and at which the magnetic material is formed as the single phase.

Since a secondary phase is not formed in this temperature range, the metal alloy may act like a liquid between the magnetic material particles without affecting physical properties of the magnetic material 24, and thus a magnetic composite 30 may be processed in various shapes using a forming mold having a predetermined shape.

That is, since the metal alloy 22 may serve as the binder between the magnetic material particles 24, the magnetic composite 30 may be formed without sintering the magnetic material.

The molding may be performed by one method selected from a hot press forming method, a hot extrusion forming method, a hot rolling forming method, and a spark plasma sintering method, but is not limited thereto.

In an example in which the magnetic composite 30 is manufactured by the hot press forming method, when a heating temperature is equal to or higher than the melting temperature of the metal alloy, the mixture may be changed in a form of a viscous flow by components of a melted metal alloy, which may serve to decrease interparticle friction between the magnetic material particles 24. Therefore, close-packing of the magnetic material particles 24 may be induced during the press forming.

Further, the metal alloy 22 may protect the magnetic material 24 in the magnetic composite 30 from being dissolved in oxygen in air, water, alcohol, or the like, thereby securing chemical stability of the magnetic composite.

The magnetic composite 30 may be processed so as to have a wide surface area in order to increase magnetic refrigeration efficiency. For example, the magnetic composite 30 may be molded into an article having one shape of a sphere, a plate, a micro-channel, a micro-fin, and a honeycomb.

### Example

The following Example is an example of a method of manufacturing a magnetic composite according to the present description. However, the present disclosure is not limited thereto.

MnCl₂, Fe, P, and Si, which were precursors, and Mg, which was a reducing agent, were weighed, respectively, at a molar ratio of 1.2:0.8:0.48:0.52, and mixed with each other for 6 hours in open air using a ball mill, thereby obtaining a mixture. The mixture was provided in a metal mold, applied with pressure using a press, and formed to be of a cylinder shape. After an alumina crucible filled with the formed mixture was put into a quartz pipe, the quartz pipe was sealed, heat-treated at 800° C. for 5 hours, and slowly cooled. The heat-treated mixture was crushed, put into a 0.1M aqueous hydrochloric acid solution, and stirred for 1 hour, thereby obtaining Mn_{1.2}Fe_{0.8}(P_{0.48}Si_{0.52}) (magnetic material), which is manganese (Mn)-iron (Fe)-phosphorus (P)-silicon (Si).

The prepared magnetic material and an Al₃₃Mg₆₇ metal alloy, which is an aluminum (AD-magnesium (Mg) alloy, were mixed with each other at a volume ratio of 5 to 20 vol %. The mixture was subjected to spark plasma sintering at 500° C. to 600° C. for 1 to 10 minutes, thereby obtaining a magnetic composite material.

A cross-section of the magnetic composite was observed using a scanning electron microscope (SEM), and a component analysis of the magnetic composite was performed using X-ray diffraction (XRD). Further, a magnetization value of the magnetic composite depending on a temperature was measured.

In Example 1, a mixture containing the magnetic material and the metal alloy (10 vol %) was sintered at 600° C. for 10 minutes; in Example 2, a mixture containing the magnetic material and the metal alloy (20 vol %) was sintered at 500° C. for 10 minutes; and in Example 3, a mixture containing the magnetic material and the metal alloy (10 vol %) was sintered at 500° C. for 10 minutes.

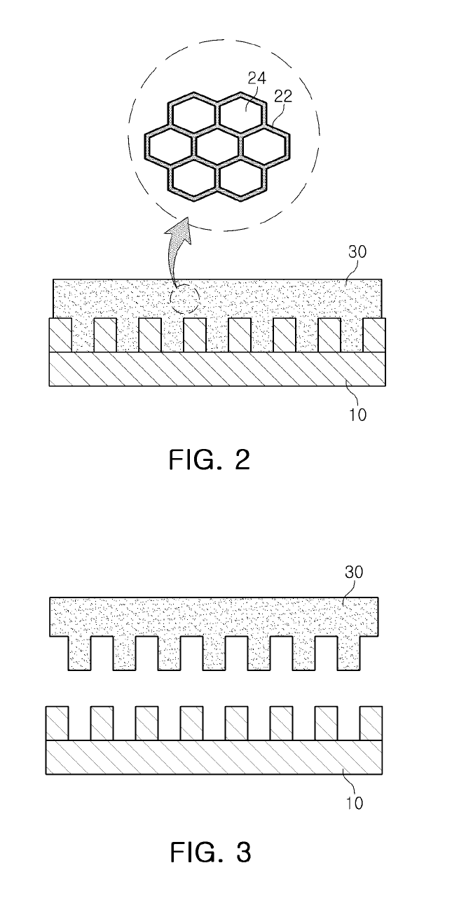

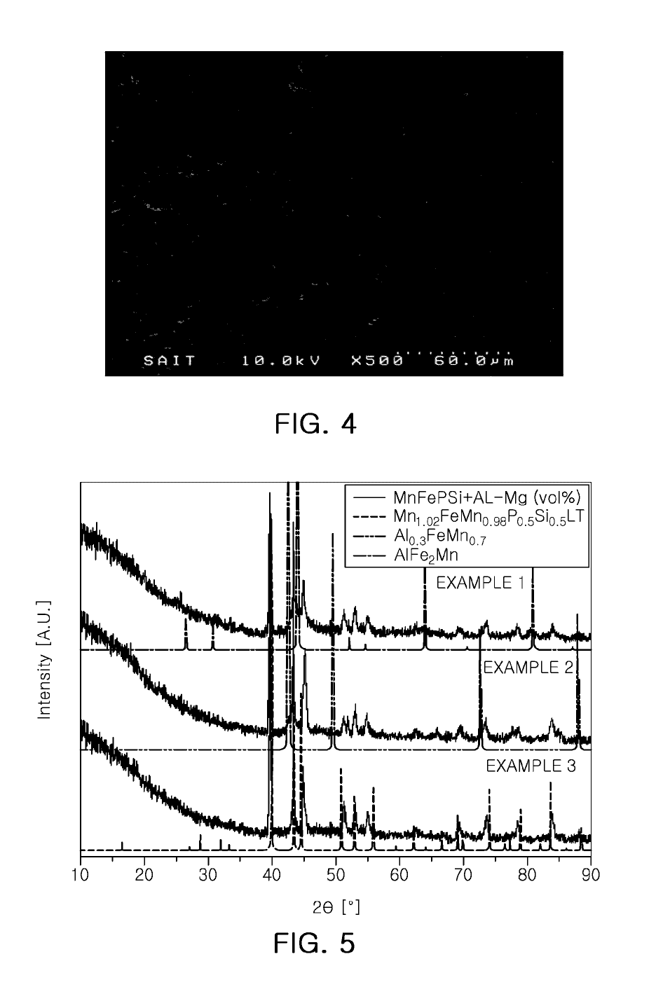

FIG. 4 is an electron microscope photograph obtained from a cross-section of an example of a magnetic composite, and FIG. 5 is a graph illustrating X-ray diffraction patterns of examples of magnetic composites.

Referring to FIGS. 4 and 5, it may be appreciated that in the Examples according to the present disclosure, the magnetic material and the metal alloy were closely bound to each other, and in Examples 1 to 3, a MnFePSi crystalline phase (low temperature phase, red color) corresponding to the magnetic material was detected as a main component.

Comparing Examples 2 and 3 with each other, it may be appreciated that in Example 3, in which 10 vol % of the metal alloy was contained, only the MnFePSi crystalline phase was detected. However, in Example 2, in which 20 vol % of the metal alloy was contained, Al_{0.3}FeMn_{0.7} corresponding to a secondary phase was formed by a reaction between aluminum (Al) corresponding to a component of the metal alloy, and the magnetic material corresponding to a main component.

Comparing Examples 1 and 2, in which the sintering temperatures were different from each other, it may be confirmed that in Example 1, in which the sintering temperature was higher than that of Example 2, Al_{0.3}FeMn_{0.7} and AlFe₂Mn secondary phases were formed. In a case in which a secondary phase formed by a reaction between components of a metal alloy and a magnetic material is contained in a magnetic composite as described above, magnetic properties and magnetic refrigeration properties of the magnetic material may be deteriorated.

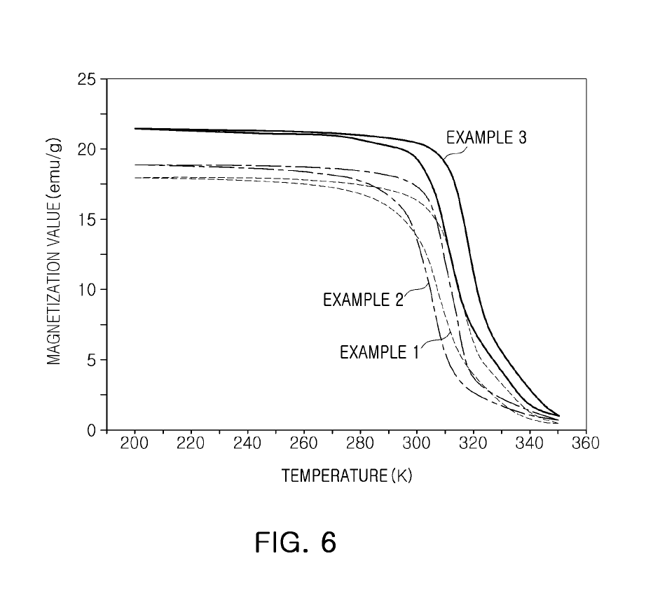

FIG. 6 is a graph illustrating magnetization of examples of magnetic composites based on a change in temperature.

Referring to FIG. 6, it may be confirmed that a phase transition from a ferromagnetic phase to a paramagnetic phase occurred at room temperature (300K) regardless of volume amounts of the metal alloy and the sintering temperature in Examples 1 to 3. However, in Examples 1 and 2, in which the secondary phase was formed, a saturation magnetization value tended to decrease as compared to Example 3.

As set forth above, an example of a magnetic composite containing a magnetic material and a metal alloy is described. According to one example, the metal alloy may serve as a binder between magnetic material particles while securing physical properties of the magnetic material. Thus, the chemical stability and mechanical properties of the magnetic composite may be improved by manufacturing the magnetic composite in accordance with the above described methods, and the magnetic composite may be easily formed into an article having various shapes.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A magnetic composite comprising:
a magnetic material comprising magnetic material particles; and
a metal alloy.

2. The magnetic composite of claim 1, wherein the metal alloy is a eutectic alloy.

3. The magnetic composite of claim 2, wherein the eutectic alloy is a binary, ternary, quaternary, or quinary alloy.

4. The magnetic composite of claim 2, wherein the eutectic alloy is an alloy comprising one or more elements selected from a group consisting of indium (In), tin (Sn), cadmium (Cd), bismuth (Bi), silver (Ag), gold (Au), lead (Pb), zinc (Zn), copper (Cu), germanium (Ge), silicon (Si), aluminum (Al), magnesium (Mg), calcium (Ca), and antimony (Sb).

5. The magnetic composite of claim 1, wherein the magnetic material particles are single phase particles dispersed in a binder comprising the metal alloy.

6. The magnetic composite of claim 1, wherein the magnetic material comprises at least one selected from a group consisting of a magnetocaloric material, a soft magnetic material, and a ferromagnetic material.

7. The magnetic composite of claim 1, wherein the magnetic material is an alloy, an oxide, or a nitride containing at least one selected from a group consisting of iron (Fe), manganese (Mn), cobalt (Co), nickel (Ni), niobium (Nb), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), boron (B), silicon (Si), germanium (Ge), gallium (Ga), arsenic (As), antimony (Sb), tellurium (Te), phosphorus (P), and bismuth (Bi).

8. The magnetic composite of claim 1, wherein a particle size of the magnetic material is 10 nm to 100 μm.

9. An article comprising the magnetic composite of claim 1, wherein the article has an outer shape of a sphere, a plate, a micro-channel, a micro-fin, or a honeycomb.

10. A method of manufacturing a magnetic composite, the method comprising:
obtaining a magnetic material;
mixing the magnetic material and a metal alloy with each other to obtain a mixture; and
forming the magnetic composite from the mixture.

11. The method of claim 10, wherein the metal alloy is a eutectic alloy.

12. The method of claim 11, wherein the eutectic alloy is a binary, ternary, quaternary, or quinary alloy.

13. The method of claim 11, wherein the eutectic alloy is an alloy comprising an element selected from a group consisting of indium (In), tin (Sn), cadmium (Cd), bismuth (Bi), silver (Ag), gold (Au), lead (Pb), zinc (Zn), copper (Cu), germanium (Ge), silicon (Si), aluminum (Al), magnesium (Mg), calcium (Ca), and antimony (Sb).

14. The method of claim 10, wherein the magnetic material comprises single phase magnetic material particles.

15. The method of claim 10, wherein the forming of the magnetic composite is performed at a temperature that is lower than a melting temperature of the magnetic material but higher than a melting temperature of the metal alloy, and at which the magnetic material is formed into single phase particles dispersed in a binder comprising the metal alloy.

16. The method of claim 10, wherein the forming of the magnetic composite is performed by one method selected from a hot press forming method, a hot extrusion forming method, a hot rolling forming method, and a spark plasma sintering method.

17. The method of claim 10, wherein the magnetic composite is formed into an article having a shape of a sphere, a plate, a micro-channel, a micro-fin, or a honeycomb.

18. A method of manufacturing a magnetic composite, the method comprising:
obtaining a mixture of a molten metal alloy and a magnetic material at a temperature between a melting temperature of the metal alloy and a melting temperature of the magnetic material; and
cooling the mixture to obtain the magnetic composite in which magnetic material particles are dispersed in the metal alloy.

19. The method of claim 18, wherein the magnetic material particles in the magnetic composite are single phase particles.

20. The method of claim 18, wherein the magnetic material particles have a particle size in a range of approximately 10 nm to 100 μm.

21. The method of claim 18, wherein the cooling of the mixture comprises molding the mixture into an article having a shape of a sphere, a plate, a micro-channel, a micro-fin, or a honeycomb.
